(19) United States
(12) Patent Application Publication
(10) Pub. No.: US 2013/0258717 A1
(43) Pub. Date: Oct. 3, 2013

(54) BACKLIGHT UNIT AND IMAGE DISPLAY APPARATUS HAVING THE SAME

(71) Applicant: SAMSUNG ELECTRONICS CO., LTD., Suwon-si (KR)

(72) Inventors: Gil-tae HUR, Seoul (KR); Nae-won JANG, Suwon-si (KR); Young-chul KIM, Yeosu-si (KR); Kun-ho CHO, Suwon-si (KR); Hyeong-sik CHOI, Hwaseong-si (KR)

(73) Assignee: SAMSUNG ELECTRONICS CO., LTD., Suwon-si (KR)

(21) Appl. No.: 13/705,299

(22) Filed: Dec. 5, 2012

(30) Foreign Application Priority Data
Mar. 28, 2012 (KR) 10-2012-0031715

(51) Int. Cl. F21V 8/00

(52) U.S. Cl. CPC G02B 6/0011
USPC 362/613

(57) ABSTRACT

A backlight unit includes a light guiding plate; a light source module that is disposed in at least one side of the light guiding plate and includes a plurality of light sources emitting light toward a side surface of the light guiding plate; an under chassis supporting the light guiding plate and the light source module; and a gap maintaining unit maintaining a gap of a constant width between the side surface of the light guiding plate and the plurality of light sources of the light source module when a length of the light guiding plate is changed.

### CROSS-REFERENCE TO RELATED APPLICATION

This application claims priority from Korean Patent Application No. 2012-0031715 filed Mar. 28, 2012 in the Korean Intellectual Property Office, the disclosure of which is incorporated herein by reference in its entirety.

### BACKGROUND

1. Field

Apparatuses and methods consistent with exemplary embodiments relate to a flat image display apparatus and, more particularly, to a backlight unit of a flat image display apparatus using a light guiding plate.

2. Description of the Related Art

A liquid crystal display apparatus displays images using a liquid crystal panel and is used in various display apparatuses such as televisions (TV), computer monitors, etc. The liquid crystal panel displays images by using liquid crystals which are a light receiving element that cannot emit light by itself. Therefore, the liquid crystal display apparatus needs a backlight unit which supplies light to the liquid crystal panel.

Accordingly, the liquid crystal display apparatus includes a liquid crystal panel assembly including the backlight unit and the liquid crystal panel. The backlight unit is disposed behind the liquid crystal panel. The backlight units are generally classified into an edge-lit backlight unit which needs the light guiding plate and a direct-lit backlight unit which does not need the light guiding plate. The direct-lit backlight unit in which a light source is disposed directly below the liquid crystal panel can operate without the light guiding plate. However, for displaying images with a good quality, it is difficult to make the liquid crystal display with the direct-lit backlight unit very thin. On the other hand, the edge-lit backlight unit, in which a light source is disposed at a side of the light guiding plate, allowing the liquid crystal display to be thinner.

FIG. 1 illustrates a liquid crystal panel assembly 1 including a related art edge-lit backlight unit 2.

Referring to FIG. 1, a light guiding plate 3 is disposed on a top surface of an under chassis 6. A plurality of light sources 4 is disposed at a side of the light guiding plate 3. In other words, the plurality of light sources 4 is disposed in a space between a middle mold 9 and a side surface of the light guiding plate 3. Also, the plurality of light source 4 is disposed on a light source board 5, and the light source board 5 is fixed to the under chassis 6 by fastening members 5a such as screws, bolts, etc. To obtain good images, a constant gap g between the light sources 4 and the side surface of the light guiding plate 3 needs to be maintained. If the gap g between the light sources 4 and the side surface of the light guiding plate 3 varies, the quality of the image being displayed on the liquid crystal panel 7 may become poor.

When the liquid crystal apparatus is used in high temperature and high humidity environments, a phenomenon that the light guiding plate 3 is expanded may occur. If the light guiding plate 3 is expanded, the gap g between the light guiding plate 3 and the light sources 4 is decreased so that the quality of the images being displayed on the liquid crystal panel 7 may decrease. Further, if the amount of expansion of the light guiding plate 3 is large, the light sources 4 disposed at a side of the light guiding plate 3 may be crashed by the expanded side surface of the light guiding plate 3, thereby being damaged.

Therefore, there is a need for the backlight unit to be used in high temperature and high humidity environments, while maintaining the constant gap between the light sources and the light guiding plate.

### SUMMARY

Exemplary embodiments may address at least the above problems and/or disadvantages and other disadvantages not described above. Also, exemplary embodiments are not required to overcome the disadvantages described above, and an exemplary embodiment may not overcome any of the problems described above.

One or more exemplary embodiments provide a backlight unit which can maintain a constant width between a light source and a light guiding plate even if the dimension of the light guiding plate is changed and can prevent the light source from being damaged by the light guiding plate, and an image display apparatus having the same.

According to an aspect of an exemplary embodiment, there is provided a backlight unit, which may include a light guiding plate; a light source module that is disposed in at least one side of the light guiding plate and includes a plurality of light sources emitting light toward a side surface of the light guiding plate; an under chassis supporting the light guiding plate and the light source module; and a gap maintaining unit constantly maintaining a gap between the side surface of the light guiding plate and the plurality of light sources of the light source module when a length of the light guiding plate is changed.

The gap maintaining unit may include a plurality of fixing members to fix the light guiding plate and the light source module to the under chassis.

The plurality of fixing members may include a plurality of studs fixed to a bottom surface of the under chassis, and the light guiding plate and the light source module may include a plurality of through holes into which the plurality of studs is inserted.

The gap maintaining unit may include fixing members to fix the light source module to the light guiding plate so that the light source module is moved integrally with the light guiding plate.

The fixing members may include anyone of studs, screws, or bolts; and the light source module may include through holes into which the fixing members are inserted.

The gap maintaining unit may include a gap making portion that is provided between the plurality of light sources of the light source module and the side surface of the light guiding plate and allows the plurality of light sources to be separated by a predetermined distance from the side surface of the light guiding plate; and a pressure member that is disposed between the under chassis and the light source module and pressurizes the light source module to the light guiding plate to allow the gap making portion to be maintained in contact with the side surface of the light guiding plate.

The gap making portion may be formed on a side surface of a light source mount of the light source module.

The gap making portion may be formed on the light source module separately from a light source mount of the light source module.

The pressure member may include a spring, an elastic member.

The pressure member may be disposed in a groove formed on the under chassis.

The light source module may be on opposite side surfaces of the light guiding plate.

### BRIEF DESCRIPTION OF THE DRAWINGS

The above and/or other aspects will become more apparent by describing certain exemplary embodiments, with reference to the accompanying drawings, in which:

FIG. 1 is a partially sectional view schematically illustrating a related art liquid crystal panel assembly;

FIG. 2 is a partially sectional view schematically illustrating a liquid crystal panel assembly according to an exemplary embodiment;

FIG. 3 is a view illustrating a light guiding plate and a light source module of the liquid crystal panel assembly of FIG. 2;

FIG. 4 is a partially sectional view schematically illustrating a liquid crystal panel assembly according to an exemplary embodiment;

FIG. 5 is a view illustrating a light guiding plate and a light source module of the liquid crystal panel assembly of FIG. 4;

FIG. 6 is a partially sectional view schematically illustrating a liquid crystal panel assembly according to an exemplary embodiment;

FIG. 7 is a partially sectional view illustrating the liquid crystal panel assembly of FIG. 6 taken along a line 7-7 in FIG. 6 for showing pressure members disposed in a groove formed on an under chassis;

FIG. 8 is a view illustrating a light guiding plate and a light source module of the liquid crystal panel assembly of FIG. 6;

FIG. 9 is a partially perspective view illustrating a portion of the light source module of the liquid crystal panel assembly of FIG. 6;

FIG. 10 is a view illustrating an example of a gap maintaining unit;

FIG. 11A is a view illustrating the liquid crystal panel assembly of FIG. 6 when a light guiding plate is not expanded;

FIG. 11B is a view illustrating the liquid crystal panel assembly of FIG. 6 when a light guiding plate is expanded; and

FIG. 12 is a sectional view conceptually illustrating an image display apparatus using a backlight unit according to an exemplary embodiment.

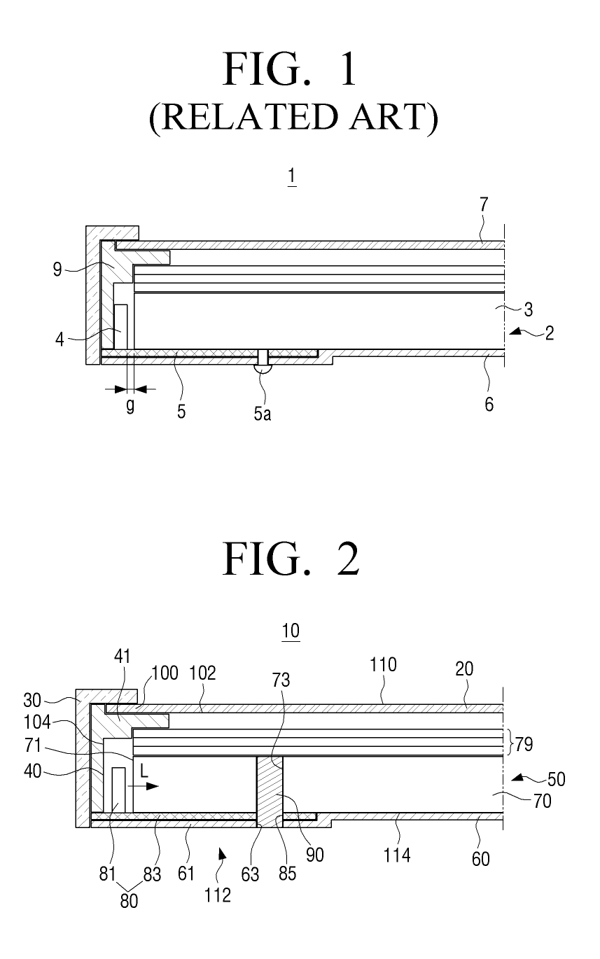

### DETAILED DESCRIPTION OF EXEMPLARY EMBODIMENTS

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail. Further, dimensions of various elements in the accompanying drawings may be arbitrarily increased or decreased for assisting in a comprehensive understanding.

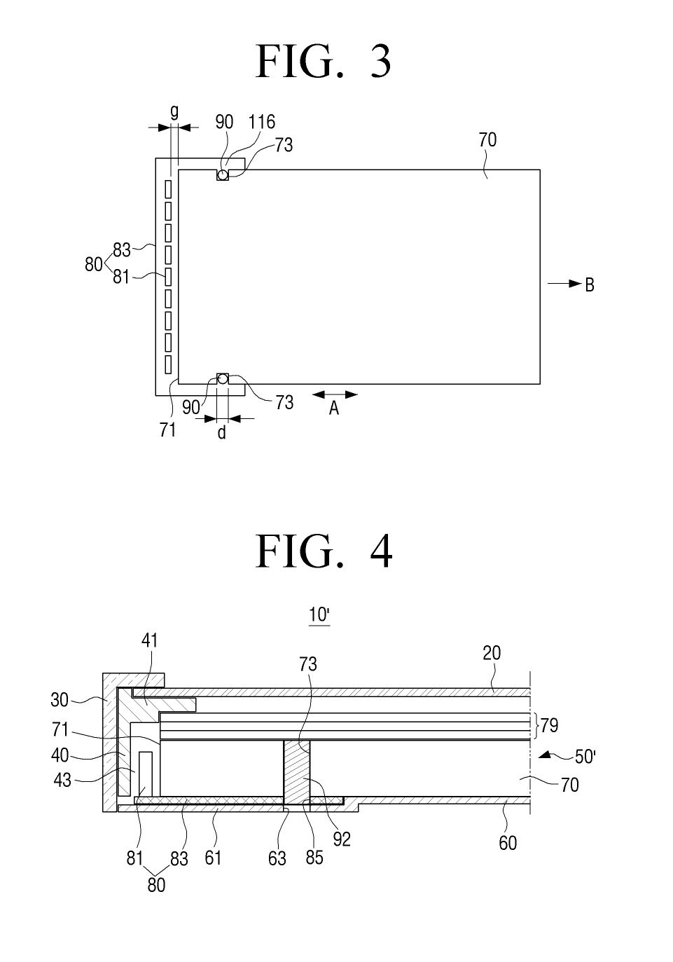

FIG. 2 is a partially sectional view schematically illustrating a liquid crystal panel assembly according to an exemplary embodiment, and FIG. 3 is a view illustrating a relationship between a light guiding plate and a light source module of the liquid crystal panel assembly of FIG. 2.

Referring to FIG. 2, the liquid crystal panel assembly 10 according to an exemplary embodiment may include a liquid crystal panel 20, an upper chassis 30, a middle mold 40, and a backlight unit 50.

The liquid crystal panel 20 displays color images by using light provided by the backlight unit 50. The liquid crystal panel 20 includes a color filter board (not illustrated) having a color filter layer and a thin film transistor board (not illustrated) having thin film transistors. A liquid crystal (not illustrated) is received between the color filter board and the thin film transistor board. A related art liquid crystal panel can be used as the liquid crystal panel 20 and, a detailed description of the liquid crystal panel 20 will be omitted.

The upper chassis 30 and the middle mold 40 fix and support the liquid crystal panel 20. The middle mold 40 may be formed in a substantially rectangular hollow frame shape. A protruding portion 41 supporting an edge portion 100 of a bottom surface 102 of the liquid crystal panel 20 is formed extending from a side surface 104 of the middle mold 40. The upper chassis 30 is disposed on a top side of the middle mold 40 and is formed substantially in the shape of the letter “L” to fix an edge portion 100 of a top surface 110 of the liquid crystal panel 20 positioned on the protruding portion 41 of the middle mold 40.

The backlight unit 50 is disposed below the liquid crystal panel 20 and supplies light to the liquid crystal panel 20. The backlight unit 50 may include an under chassis 60, a light guiding plate 70, a light source module 80, optical sheets 79, and a gap maintaining unit 90, i.e., a fixing member.

The under chassis 60 supports the light guiding plate 70 and the light source module 80 and has a space in which the light guiding plate 70 and the light source module 80 can be accommodated. A light source module receiving portion 61 which is bent and accommodates the light source module 80 is provided on an end portion 112 of the under chassis 60. Although not illustrated, if the light source module 80 is disposed on each of the opposite end portions of the light guiding plate 70, two light source module receiving portions 61 are provided on the under chassis 60.

The light guiding plate 70 minimizes loss of light L emitting from the light source module 80 disposed at a side of the light guiding plate 70, evenly disperses the light L to the entire surface of the liquid crystal panel 20, and collects the light L in the same direction. The light guiding plate 70 is formed in a rectangular shape, has a size corresponding to the liquid crystal panel 20, and is disposed on a top surface of the under chassis 60. At least two first through holes 73 may be formed on the light guiding plate 70. Referring to FIG. 3, in the present exemplary embodiment, two first through holes 73 are formed near one side surface 71 of the light guiding plate 70. The first through holes 73 are formed in a groove shape so that one side surface 116 of the first through hole 73 is open.

The light source module 80 is disposed at a side of the light guiding plate 70, and includes a plurality of light sources 81 emitting light L toward the light guiding plate 70 and a light source board 83 on which the plurality of light sources 81 is disposed and an electric circuit to drive the plurality of light sources 81 is provided. The plurality of light sources 81, as illustrated in FIG. 3, is disposed on the light source board 83 to form a straight line parallel to the side surface 71 of the light guiding plate 70. The light source board 83 may be formed of aluminum. The plurality of light sources 81 may use light emitting diodes (LEDs) or cold cathode fluorescent lamps (CCFLs). Although the backlight units using LEDs as the light sources 81 are described in detail below, this is not limited thereto.

The optical sheets 79 are disposed on a front surface of the light guiding plate 70, proximate the liquid crystal panel 20. The optical sheets 79 minimize waste of light by refraction and reflection of the light, improve brightness of the light emitting through the light guiding plate 70, and evenly disperse the light. The optical sheets 79 may include a diffuser sheet to evenly diffuse light, a prism sheet to refract light and enhance brightness, and a dual brightness enhancement film (DBEF) to selectively transmit and reflect light so as to enhance brightness. The optical sheets 79 may be the same as the optical sheets used in the related art backlight unit 2, and detailed description thereof will be omitted.

Although the length of the light guiding plate 70 is increased or reduced, the gap maintaining unit 90 allows the gap g between the plurality of light sources 81 and the side surface 71 of the light guiding plate 70 to be maintained at a constant width. The gap maintaining unit 90 may be formed as a plurality of fixing members to fix the light source module 80 and the light guiding plate 70 integrally to the under chassis 60. The fixing member 90 may be formed as a stud having a cylindrical shape which may be fixed to the under chassis 60.

As illustrated in FIGS. 2 and 3, the light source module receiving portion 61 of the under chassis 60 is provided with a plurality of second through holes 63 into which the fixing member 90 can be inserted, the light source module 80 is provided with a plurality of third through holes 85 into which the fixing member 90 can be inserted, and the light guiding plate 70 is provided with a plurality of first through holes 73 into which the fixing member 90 can be inserted. The third and first through holes 85 and 73 formed in the light source module 80 and the light guiding plate 70 may be formed to have a dimension such that after the fixing members 90 are inserted in the third and first through holes 85 and 73, the light source module 80 and the light guiding plate 70 are not moved in the lengthwise direction (a direction of arrow A) of the light guiding plate 70. In other words, the dimensions of the fixing members 90 and the third and first through holes 85 and 73 may be determined so that after the fixing members 90 are inserted in the third through holes 85 of the light source module 80 and the first through hole 73 of the light guiding plate 70, the light guiding plate 70 and the light source module 80 do not move with respect to the fixing member 90. Also, if the first through holes 73, as illustrated in FIG. 3, are formed in a groove shape, a distance d between opposite side surfaces of the first through holes 73 may be determined so that the light guiding plate 70 does not move with respect to the fixing member 90 in the direction of arrow A.

After the plurality of second, third, and first through holes 63, 85 and 73 are aligned with each other, and then, the fixing member 90 is inserted into the second, third and first through holes 63, 85 and 73, the light guiding plate 70 and the light source module 80 are fixed to the under chassis 60 and do not move with respect to the under chassis 60. As a result, the light guiding plate 70, the light source module 80, and the under chassis 60 form a single body so that even when, due to expansion or contraction of the light guiding plate 70, the length of the light guiding plate 70 is increased or reduced, the gap g between the plurality of light sources 81 of the light source module 80 and one side surface 71 of the light guiding plate 70 is not changed but constantly maintained. When the light guiding plate 70 is expanded, a side surface of the light guiding plate 70 which does not face the light source module 80 is increased in a direction of arrow B of FIG. 3. Accordingly, a space that can absorb the expansion of the light guiding plate 70 is provided in the other side of the under chassis 60 in which the light source module 80 is not disposed.

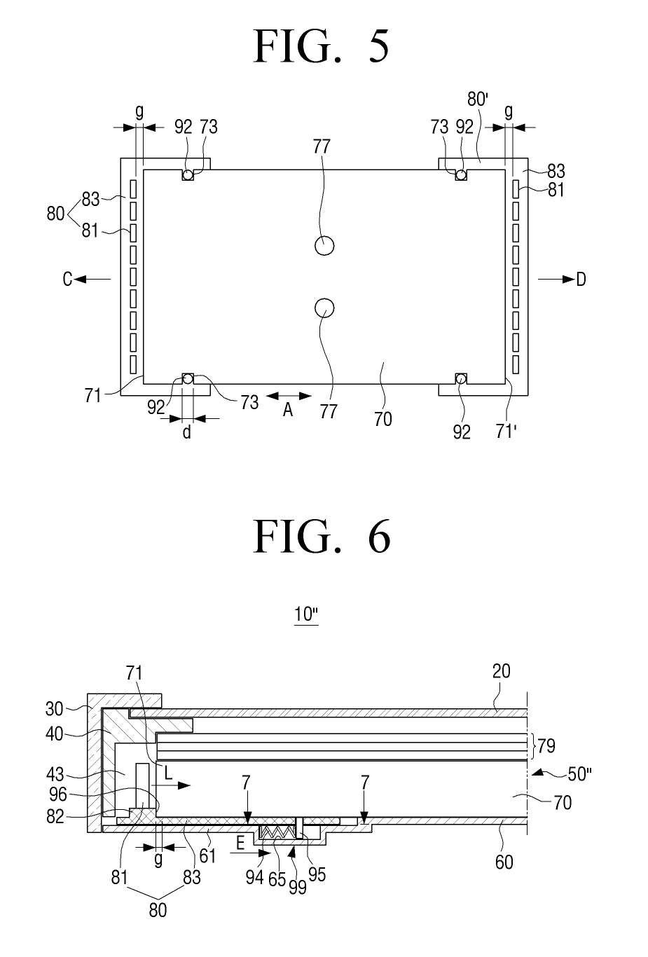

Hereinafter, referring to FIGS. 4 and 5, a liquid crystal panel assembly 10′ including a backlight unit 50′ according to another exemplary embodiment will be described.

FIG. 4 is a partially sectional view schematically illustrating a liquid crystal panel assembly 10′ including a backlight unit 50′ according to an exemplary embodiment, and FIG. 5 is a view illustrating a relationship between a light guiding plate 70 and a light source module 80 of the liquid crystal panel assembly 10′ of FIG. 4.

Referring to FIG. 4, the liquid crystal panel assembly 10′ according to an exemplary embodiment may include a liquid crystal panel 20, an upper chassis 30, a middle mold 40, and a backlight unit 50′. The liquid crystal panel 20, the upper chassis 30, and the middle mold 40 are the same as those of the liquid crystal panel assembly 10 according to the above-described exemplary embodiment; therefore, detailed descriptions thereof will be omitted.

The backlight unit 50′ is disposed below the liquid crystal panel 20, and supplies light to the liquid crystal panel 20. The backlight unit 50′ may include an under chassis 60, a light guiding plate 70, a light source module 80, optical sheets 79, and a gap maintaining unit 92. The backlight unit 50′ according to the present exemplary embodiment is similar to the backlight unit 50 as described above. In other words, structures and functions of the under chassis 60, the light guiding plate 70, the light source module 80, and the optical sheets 79 are the same as those of the under chassis 60, the light guiding plate 70, the light source module 80, and the optical sheets 79 of the backlight unit 50 as described above. However, there is a difference that only the light guiding plate 70 and the light source module 80 are integrally fixed by the gap maintaining unit 92, and the under chassis 60 is not fixed integrally with the light guiding plate 70 and the light source module 80.

Referring to FIG. 4, the gap maintaining unit 92 may include a plurality of fixing members that fix the light source module 80 integrally to a side of the light guiding plate 70 and may be formed as one or more studs having a cylindrical shape.

The light source module 80 is provided with a plurality of third through holes 85 into which the fixing member 92 can be inserted, and the light guiding plate 70 is provided with a plurality of first through holes 73 into which the fixing member 92 can be inserted. The third and first through holes 85 and 73 may be formed to have a dimension such that after the fixing member 92 is inserted in the third and first through holes 85 and 73, the light source module 80 and the light guiding plate 70 are not moved with respect to the fixing member 92 in the lengthwise direction of the light guiding plate 70 so that when the one side surface 71 of the light guiding plate 70 is moved to the lengthwise direction thereof (a direction of arrow A), the light source module 80 also is moved by the same distance and in the same direction as the movement of the light guiding plate 70. In other words, the dimensions of the third and first through holes 85 and 73 and the fixing member 92 may be determined so that when the fixing member 92 is inserted in the third through holes 85 of the light source module 80 and the first through holes 73 of the light guiding plate 70, the light source module 80 is not moved in the direction of arrow A. Also, if the first through holes 73 formed on the light guiding plate 70 are formed in a groove shape having one open side as illustrated in FIG. 5, a distance d between opposite side surfaces of the first through holes 73 may be determined so that the light guiding plate 70 does not move with respect to the fixing member 92 in the direction of arrow A.

The under chassis 60 may be provided with second through holes 63 through which the fixing member 92 can be inserted into the third through holes 85 of the light source module 80 and the first through holes 73 of the light guiding plate 70.

A space 43 is formed between the middle mold 40 and the plurality of light sources 81 of the light source module 80 so that when the light guiding plate 70 is expanded, the light source module 80 can be moved therein. The width of the space 43 may be determined to accommodate the maximum length to which the light guiding plate 70 may expand.

The gap maintaining unit 92 according to the present exemplary embodiment may be applied to the backlight unit 50′ having the light source modules 80 and 80′ disposed on the opposite sides of the light guiding plate 70 as illustrated in FIG. 5. The light guiding plate 70 is fixed to the under chassis 60 by at least two light guiding plate fixing members 77 disposed in a center portion 120 thereof. As a result, when the light guiding plate 70 is expanded due to surrounding environments, the opposite side surfaces 71 and 71′ of the light guiding plate 70 are increased in the left and right directions (directions of arrows C and D). In the present exemplary embodiment, since the light source modules 80 and 80′ are fixed to move integrally with the light guiding plate 70, even when the opposite side surfaces 71 and 71′ of the light guiding plate 70 are increased in the left and right directions, the gap g between the side surface 71 or 71′ of the light guiding plate 70 and the plurality of light sources 81 of the light source module 80 or 80′, respectively, is maintained to be of a constant width.

Hereinafter, referring to FIGS. 6 to 9, a liquid crystal panel assembly 10″ including a backlight unit 50″ according to another exemplary embodiment will be described.

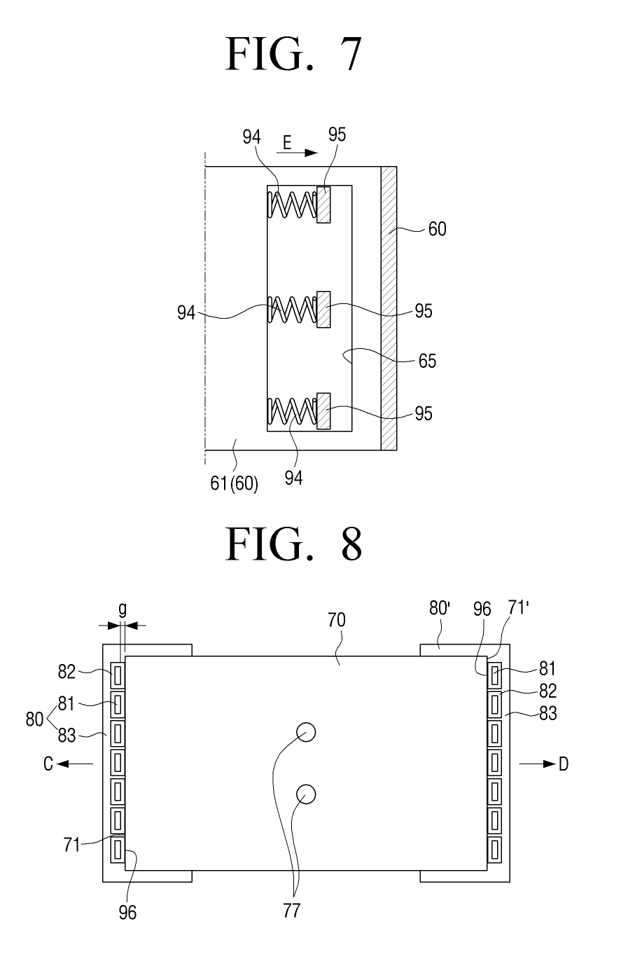

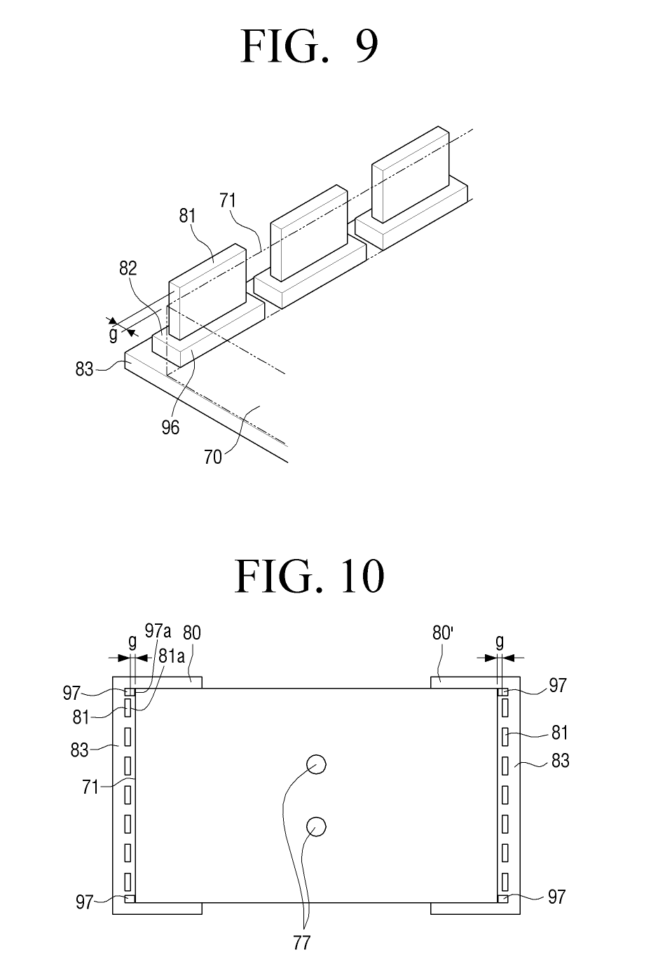

FIG. 6 is a partially sectional view schematically illustrating a liquid crystal panel assembly 10″ including a backlight unit 50″ according to an exemplary embodiment, and FIG. 7 is a partially sectional view illustrating the liquid crystal panel assembly of FIG. 6 taken along a line 7-7 in FIG. 6 for showing pressure members disposed in a groove formed on an under chassis 60. Also, FIG. 8 is a view illustrating a relationship between a light guiding plate 70 and a light source module 80 of the liquid crystal panel assembly 10″ of FIG. 6. FIG. 9 is a partially perspective view illustrating a portion of the light source module 80 of the liquid crystal panel assembly 10″ of FIG. 6.

Referring to FIG. 6, the liquid crystal panel assembly 10″ according to an exemplary embodiment may include a liquid crystal panel 20, an upper chassis 30, a middle mold 40, and a backlight unit 50″. The liquid crystal panel 20, the upper chassis 30, and the middle mold 40 are the same as those of the liquid crystal panel assembly 10 according to the above-described exemplary embodiment; therefore, detailed descriptions thereof will be omitted.

The backlight unit 50″ is disposed below the liquid crystal panel 20, and supplies light to the liquid crystal panel 20. The backlight unit 50″ may include an under chassis 60, a light guiding plate 70, a light source module 80, optical sheets 79, and a gap maintaining unit 99. The backlight unit 50″ according to the present exemplary embodiment is similar to the backlight unit 50′ as described above. In other words, structures and functions of the under chassis 60, the light guiding plate 70, the light source module 80, and the optical sheets 79 are the same as the under chassis 60, the light guiding plate 70, the light source module 80, and the optical sheets 79 of the backlight unit 50′ as described above. However, the gap maintaining unit 99 is different from the gap maintaining unit 92 of the backlight unit 50′.

Referring to FIGS. 6 and 7, the gap maintaining unit 99 may include a gap making portion 96 and at least one pressure member 94. The gap making portion 96 is provided between the plurality of light sources 81 of the light source module 80 and the side surface 71 of the light guiding plate 70 and allows the plurality of light sources 81 to be spaced a predetermined distance apart from the side surface 71 of the light guiding plate 70. Accordingly, when the side surface 71 of the light guiding plate 70 is in contact with the gap making portion 96, the gap g between the plurality of light sources 81 and the side surface 71 of the light guiding plate 70 becomes a dimension determined during a design process thereof. The gap making portion 96 may be formed on either of the light source module 80 or the light guiding plate 70. In the present exemplary embodiment, the gap making portion 96 is provided with the light source module 80 for manufacturing convenience.

Referring to FIGS. 6, 8 and 9, the gap making portion 96 is provided on a side surface of a light source mount 82 formed on a light source board 83 of the light source module 80. The light source mount 82 is to mount the plurality of light sources 81. The light source mounts 82 are formed to correspond to the number of the light sources 81 and project upward from the light source board 83. Accordingly, one side surface of the light source mount 82 may be machined to form the gap making portion 96. If the machined surface of the light source mount 82, that is the gap making portion 96, is in contact with the side surface 71 of the light guiding plate 70, the plurality of light sources 81 and the side surface 71 of the light guiding plate 70 are parallel to each other, and the gap g between the plurality of light sources 81 and the side surface 71 of the light guiding plate 70 becomes a dimension determined during a design process thereof.

Alternatively, as illustrated in FIG. 10, gap making portions 97 may not use the plurality of light source mounts 82, but be formed on the light source board 83 separately from the light source mounts 82.

Referring to FIG. 10, the gap making portions 97 are disposed at opposite ends of the plurality of light sources 81 of the light source modules 80 and 80′. The gap making portion 97 is formed in a protrusion projecting upwardly from the light source board 83. One surface of the protrusion 97 is machined parallel to light emitting surfaces 81a of the plurality of light sources 81. Further, the first surface 97a of the protrusion 97 is machined so that a gap between the light emitting surfaces 81a of the plurality of light sources 81 and the first surface 97a of the protrusion 97 is a dimension of the gap g between the light sources 81 and the side surface 71 of the light guiding plate 70 determined by design. As a result, as illustrated in FIG. 10, when the side surface 71 of the light guiding plate 70 is in contact with the first surface 97a of the protrusion 97, the gap g between the plurality of light sources 81 and the side surface 71 of the light guiding plate 70 becomes the dimension determined by design.

Referring to FIGS. 6, 7 and 8 again, the pressure member 94 allows the gap making portion 96 of the light source module 80 to keep in contact with the side surface 71 of the light guiding plate 70 and is disposed between the under chassis 60 and the light source module 80. In other words, the pressure member 94 pressurizes the light source module 80 to the side surface 71 of the light guiding plate 70 so that the gap making portion 96 keeps in contact with the one side surface 71 of the light guiding plate 70. As a result, the gap g between the plurality of light sources 81 of the light source module 80 and the side surface 71 of the light guiding plate 70 is maintained to be of a constant width.

As illustrated in FIGS. 6 and 7, the pressure member 94 is disposed in a groove 65 formed on the under chassis 60. In order to uniformly pressurize the light source module 80, a plurality of pressure members 94 may be disposed in a width direction of the light guiding plate 70.

Referring to FIG. 7, three pressure members 94 are disposed to pressurize three pressure projections 95 of the light source module 80. The pressure member 94 may be variously formed as long as the pressure member 94 can pressurize the light source module 80 in one direction. For example, the pressure member 94 may be an elastic member such as a coil spring, a plate spring, a rubber, etc. In FIGS. 6 and 7, the coil springs are used as the pressure member 94.

Referring to FIGS. 6 and 7, one end of the pressure member 94 is fixed to the pressure projection 95 projecting downward from the light source module 80 and the other end of the pressure member 94 is fixed to a side wall of the groove 65 formed on the under chassis 60. Accordingly, the pressure member 94 is applying a force to the pressure projection 95 in a direction of arrow E. Since the light source module 80 also receives a force in the direction of arrow E by the pressure member 94, the gap making portion 96 formed on the light source module 80 keeps in contact with the one side surface 71 of the light guiding plate 70. A bottom surface of the light source module 80 and a top surface of the under chassis 60 may be formed so that the light source module 80 can smoothly slide with respect to the top surface of the under chassis 60.

The pressure projection 95 is formed to project downward from the bottom surface of the light source board 83 of the light source module 80, and is inserted in the groove 65 formed on the under chassis 60. The pressure projection 95 may be formed to have a narrow width and the number of the pressure projections 95 may correspond to the number of the pressure members 94. For example, screws or bolts, which are tightened to the light source board 83, may be used as the pressure projections 95. Alternatively, although not illustrated, the pressure projection 95 may be a single projection having a length corresponding to the length of the light source module 80, and the plurality of pressure members 94 may pressurize the single pressure projection 95.

The gap maintaining unit 99 according to the present exemplary embodiment may be applied to the backlight unit 50″ having light source modules 80 and 80′ disposed on the opposite sides of the light guiding plate 70 as illustrated in FIG. 8. At this time, the light guiding plate 70 is fixed to the under chassis 60 by at least two light guiding plate fixing members 77 disposed in a center thereof. Accordingly, when the light guiding plate 70 is expanded by surrounding environments, the opposite side surfaces 71 and 71′ of the light guiding plate 70 are increased in the left and right directions (directions of arrows C and D). In the present exemplary embodiment, since the gap making portion 96 of the light source modules 80 and 80′ is kept in contact with the side surfaces 71 and 71′ of the light guiding plate 70 by the pressure member 94, even when the opposite side surfaces 71 and 71′ of the light guiding plate 70 are increased in the left and right directions, the gap g between the respective side surface 71 or 71′ of the light guiding plate 70 and the plurality of light sources 81 of the light source modules 80 and 80′ is maintained.

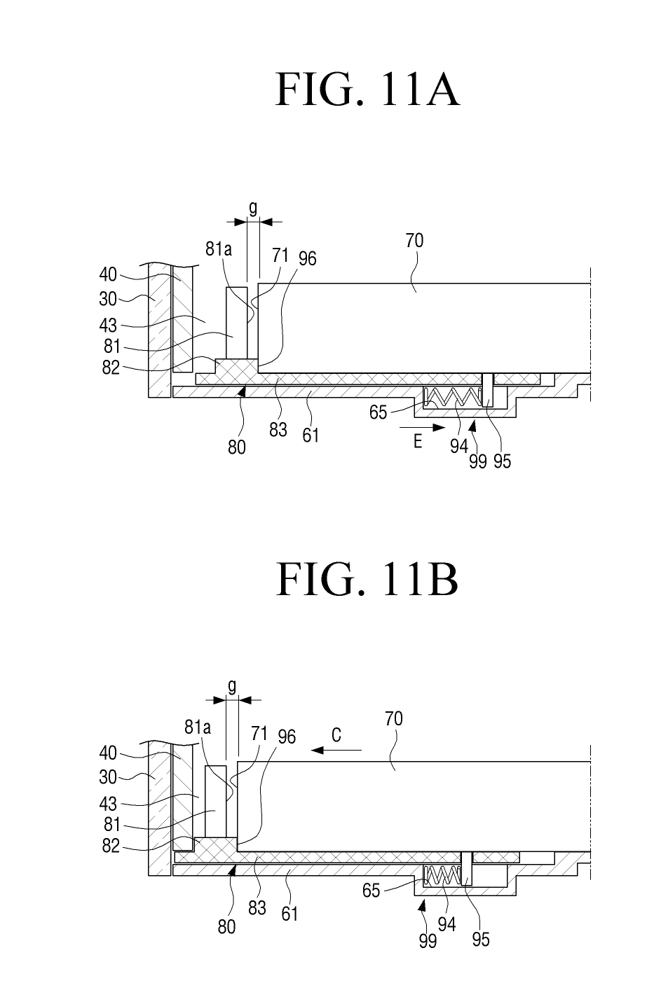

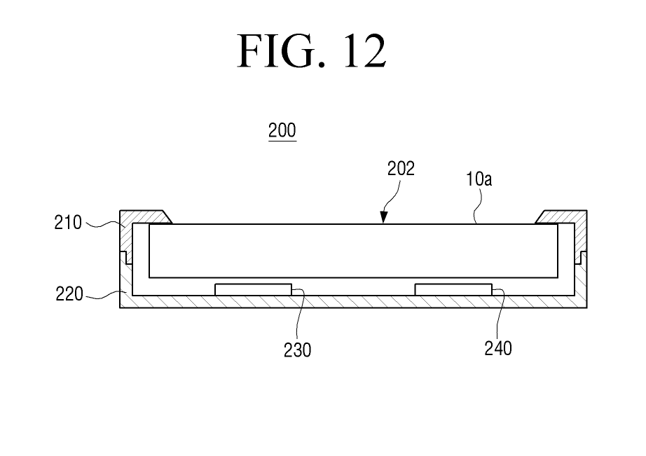

Hereinafter, referring to FIG. 11A and 11B, operation of the gap maintaining unit 99 according to the present exemplary embodiment that maintains the gap g between the plurality of light sources 81 and the one side surface 71 of the light guiding plate 70 will be described.

FIG. 11A is a view illustrating the gap maintaining unit 99 of the liquid crystal panel assembly 10″ of FIG. 6 when the light guiding plate 70 is not expanded, and FIG. 11B is a view illustrating the gap maintaining unit 99 of the liquid crystal panel assembly 10″ of FIG. 6 when the light guiding plate 70 is expanded.

When the light guiding plate 70 is not expanded or contracted due to the surrounding environment, as illustrated in FIG. 11A, since the pressure member 94 pressurizes the pressure projection 95 of the light source module 80 in the direction of arrow E, the gap making portion 96 of the light source module 80 contacts the side surface 71 of the light guiding plate 70. Accordingly, the gap g between the plurality of light sources 81 of the light source module 80 and the side surface 71 of the light guiding plate 70 is maintained by a predetermined dimension.

If an image display apparatus 200 (see FIG. 12) is used in high-temperature and high-humidity environment, the light guiding plate 70 may be expanded. When the light guiding plate 70 is expanded, the side surface 71 of the light guiding plate 70 is moved in a direction of arrow C as illustrated in FIG. 11B. Since the gap making portion 96 receives a force by the light guiding plate 70, the light source module 80 also is moved in the direction of arrow C along with the one side surface 71 of the light guiding plate 70. When the light source module 80 is moved in the direction of arrow C, the pressure member 94 disposed in the groove 65 of the under chassis 60 receives a force by the pressure projection 95, and is compressed as illustrated in FIG. 11B.

After that, when the light source module 80 is restored to an original state, the light source module 80 receives a force in the direction of arrow E by a restoring force of the pressure member 94. As a result, the gap making portion 96 of the light source module 80 keeps in contact with the one side surface 71 of the light guiding plate 70 and is restored to an original state.

In the backlight unit 50″ according to an exemplary embodiment, even when the length of the light guiding plate 70 is reduced due to the surrounding environment, since the pressure member 94 pressurizes the light source module 80, the gap making portion 96 of the light source module 80 can keep in contact with the side surface 71 of the light guiding plate 70. Accordingly, even when the length of the light guiding plate 70 is reduced, the gap g between the light source 81 and the one side surface 71 of the light guiding plate 70 can be maintained constant.

Since the backlight unit 50″ according to the present exemplary embodiment is formed so that the gap making portion 96 of the light source module 80 is in close contact with the side surface 71 of the light guiding plate 70 by the pressure member 94, even when the light guiding plate 70 is expanded or contracted due to surrounding environment, the gap g between the plurality of light sources 81 of the light source module 80 and the side surface 71 of the light guiding plate 70 can be maintained per the original design dimension.

FIG. 12 is a sectional view conceptually illustrating an image display apparatus using a backlight unit according to an exemplary embodiment.

FIG. 12 shows a liquid crystal display television (LCD TV) as one example of the image display apparatus 200. However, the present disclosure can be applied to other types of flat image display apparatuses, such as computer monitors, etc.

The image display apparatus 200 includes an upper housing 210 and an under housing 220. The liquid crystal panel assembly 202, which may include the liquid crystal panel assembly 10, 10′ or 10″ according to an exemplary embodiment described above, is received inside the upper and under housings 210 and 220.

As described above, the backlight unit 50, 50′ or 50″ of the liquid crystal panel assembly 10, 10′ or 10″ may include a gap maintaining unit 90, 92 or 99 allowing the gap g between the one side surface 71 of the light guiding plate 70 and the plurality of light sources 81 of the light source module 80 to be maintained at a constant width.

A power board 230 to supply electric power to the image display apparatus 200 and a control board 240 to control operation of the image display apparatus 200 are arranged behind the liquid crystal panel assembly 10, 10′ or 10″. Although FIG. 12 illustrates only the power board 230 and the control board 240, the image display apparatus 200 can additionally include other printed circuit boards for other functions.

As described above, even if the dimension of the light guiding plate 70 is increased or reduced, the gap g between the plurality of light sources 81 of the light source module 80 and the side surface 71 of the light guiding plate 70 is maintained at a constant width by providing the backlight unit 50, 50′ and 50″ formed so that the light source module 80 is fixed to the under chassis 60 along with the light source module 80 or including the gap maintaining unit 92 and 99 that allows the light source module 80 to move integrally with the light guiding plate 70 is disposed in the liquid crystal panel assembly 10, 10′ and 10″. Accordingly, the image display apparatus 200 of FIG. 12 including the liquid crystal panel assembly 10, 10′, or 10″ does not get broken down due to the surrounding environment.

Although a few exemplary embodiments have been shown and described, it will be appreciated by those skilled in the art that changes may be made in the exemplary embodiments without departing from the principles and spirit of the invention, the scope of which is defined in the appended claims and their equivalents.

What is claimed is:

1. A backlight unit comprising:
a light guiding plate;
a light source module that is disposed in at least one side of the light guiding plate and includes a plurality of light sources emitting light toward a side surface of the light guiding plate;
an under chassis which supports the light guiding plate and the light source module; and
a gap maintaining unit which maintains a gap of a constant width between the side surface of the light guiding plate and the plurality of light sources of the light source module when a length of the light guiding plate is changed.

2. The backlight unit of claim 1, wherein the gap maintaining unit comprises a plurality of fixing members to fix the light guiding plate and the light source module to the under chassis.

3. The backlight unit of claim 2, wherein:
the plurality of fixing members comprises a plurality of studs fixed to a bottom surface of the under chassis, and
the light guiding plate and the light source module comprise a plurality of through holes into which the plurality of studs is inserted.

4. The backlight unit of claim 1, wherein the gap maintaining unit comprises fixing members to fix the light source module to the light guiding plate so that the light source module is moved integrally with the light guiding plate.

5. The backlight unit of claim 4, wherein:
the fixing members comprise at least one of studs, screws, or bolts; and
the light source module comprises through holes into which the fixing members are inserted.

6. The backlight unit of claim 1, wherein the gap maintaining unit comprises:
a gap making portion that is provided between the plurality of light sources of the light source module and the side surface of the light guiding plate and separates the plurality of light sources from the side surface of the light guiding plate by a predetermined gap; and
a pressure member that is disposed between the under chassis and the light source module and pressurizes the light source module to the light guiding plate to maintain the gap making portion in contact with the side surface of the light guiding plate.

7. The backlight unit of claim 6, wherein the gap making portion is formed on a side surface of a light source mount of the light source module.

8. The backlight unit of claim 6, wherein the gap making portion is formed on the light source module separately from a light source mount of the light source module.

9. The backlight unit of claim 6, wherein the pressure member comprises one of a spring and an elastic member.

10. The backlight unit of claim 6, wherein the pressure member is disposed in a groove formed on the under chassis.

11. The backlight unit of claim 6, wherein the light source module is disposed on opposite side surfaces of the light guiding plate.

12. An image display apparatus comprising:
a liquid crystal panel;
an upper chassis which supports the liquid crystal panel; and
a backlight unit that is disposed below the liquid crystal panel and emits light to the liquid crystal panel, the backlight unit comprising:
a light guiding plate;
a light source module that is disposed in at least one side of the light guiding plate and includes a plurality of light sources emitting light toward a side surface of the light guiding plate;
an under chassis which supports the light guiding plate and the light source module; and
a gap maintaining unit which maintains a gap of a constant width between the side surface of the light guiding plate and the plurality of light sources of the light source module when a length of the light guiding plate is changed.

13. A backlight comprising:
a light guiding plate;
an under chassis which is disposed underneath the light guiding plate and comprises a bent portion;
a light source module including:
light sources disposed proximate a side surface of the light guiding plate, and
a board on which the light sources are mounted and which extends between the light guiding plate and the bent portion of the under chassis; and
a gap maintaining unit which is disposed proximate the side surface of the light guiding plate and the bent portion of the under chassis and maintains a constant width between the side surface of the light guiding plate and the light sources when a length of the light guiding plate is changed, in a first direction substantially perpendicular to the side surface.

14. The backlight of claim 13, wherein the gap maintaining unit comprises a fixing member which fixes the light guiding plate, the board, and the under chassis to one another.

15. The backlight of claim 14, wherein the light guiding plate, the board, and the under chassis comprise openings which are aligned with one another and through which the fixing member is inserted to fix the light guiding plate, the board, and the under chassis to one another.

16. The backlight of claim 13, wherein the gap maintaining unit comprises a fixing member which fixes the board to the light guiding plate to form an integral module comprising the light source module and the light guiding plate configured to move together in the first direction.

17. The backlight of claim 16, wherein the light guiding plate and the board comprise openings which are aligned with one another and through which the fixing member is inserted to fix the light guiding plate and the board to one another.

18. The backlight of claim 13, wherein the gap maintaining unit comprises:
a gap making portion that is formed on the board between the light sources and the side surface of the light guiding plate and separates the light sources from the side surface of the light guiding plate by a gap; and
a pressure member that is disposed between the under chassis and the board and pressurizes the light source module to the light guiding plate to maintain the gap making portion in contact with the side surface of the light guiding plate.
